(19) United States
(12) Patent Application Publication
(10) Pub. No.: US 2008/0318086 A1
(43) Pub. Date: Dec. 25, 2008

(54) SURFACE-TREATED FERROELECTRIC MEDIA FOR USE IN SYSTEMS FOR STORING INFORMATION

(75) Inventors: Byong Man Kim, Fremont, CA (US); Donald Edward Adams, Pleasanton, CA (US); Brett Eldon Huff, Fremont, CA (US); Yevgeny V. Anoikin, Fremont, CA (US); Robert N. Stark, Saratoga, CA (US)

Correspondence Address: FLIESLER MEYER LLP, 650 CALIFORNIA STREET, 14TH FLOOR, SAN FRANCISCO, CA, 94108, US

(73) Assignee: NANOCHIP, INC., Fremont, CA (US)

(21) Appl. No.: 11/765,256

(22) Filed: Jun. 19, 2007

(51) Int. Cl. G11B 5/66

(52) U.S. Cl. 428/827

(57) ABSTRACT

A system for storing information comprises a media including a ferroelectric layer and a passivation layer formed over the ferroelectric layer, and a tip arranged in approximate contact with the passivation layer. The tip detects a polarization signal that corresponds to changes in polarization of domains of the ferroelectric layer.

### TECHNICAL FIELD

This invention relates to systems for storing information.

### BACKGROUND

Software developers continue to develop steadily more data intensive products, such as ever-more sophisticated, and graphic intensive applications and operating systems (OS). Each generation of application or OS always seems to earn the derisive label in computing circles of being “a memory hog.” Higher capacity data storage, both volatile and non-volatile, has been in persistent demand for storing code for such applications. Add to this need for capacity, the confluence of personal computing and consumer electronics in the form of personal MP3 players, such as iPod®, personal digital assistants (PDAs), sophisticated mobile phones, and laptop computers, which has placed a premium on compactness and reliability.

Nearly every personal computer and server in use today contains one or more hard disk drives for permanently storing frequently accessed data. Every mainframe and supercomputer is connected to hundreds of hard disk drives. Consumer electronic goods ranging from camcorders to digital video recorders (DVRs) use hard disk drives. While hard disk drives store large amounts of data, they consume a great deal of power, require long access times, and require “spin-up” time on power-up. FLASH memory is a more readily accessible form of data storage and a solid-state solution to the lag time and high power consumption problems inherent in hard disk drives. Like hard disk drives, FLASH memory can store data in a non-volatile fashion, but the cost per megabyte is dramatically higher than the cost per megabyte of an equivalent amount of space on a hard disk drive, and is therefore sparingly used. Consequently, there is a need for solutions which permit higher density data storage at a reasonable cost per megabyte.

### BRIEF DESCRIPTION OF THE DRAWINGS

Further details of the present invention are explained with the help of the attached drawings in which:

FIG. 1A is a cross-sectional schematic diagram of a tip positioned over a ferroelectric media having a hydrocarbon layer formed over the surface of the ferroelectric media.

FIG. 1B is a cross-sectional schematic diagram of an embodiment of a system and method for storing information in accordance with the present invention including a tip positioned over a ferroelectric media having a passivation layer formed over the surface of the ferroelectric media.

FIG. 2 is a scanning-electron microscope image of an atomic force microscope probe tip before and after movement over a ferroelectric media under different operating conditions.

FIG. 3 is a cross-sectional schematic diagram of a tip positioned over a ferroelectric media having an oxygen-enriched layer formed over the surface of the ferroelectric media.

FIG. 4 is a flow chart of an embodiment of a method in accordance with the present invention for forming a ferroelectric media having a passivation layer.

FIG. 5 is a cross-sectional view of a system for storing information including a cavity within which can be disposed nitrogen gas.

FIG. 6 is a first set of RF-charge signals detected by an atomic force microscope probe tip under different operating conditions.

FIG. 7 is a second set of RF-charge signals detected by an atomic force microscope probe tip under different operating conditions.

### DETAILED DESCRIPTION

Ferroelectrics are members of a group of dielectrics that exhibit spontaneous polarization—i.e., polarization in the absence of an electric field. Ferroelectrics are the dielectric analogue of ferromagnetic materials, which may display permanent magnetic behavior. Permanent electric dipoles exist in ferroelectric materials. One common ferroelectric material is lead zirconate titanate (Pb[ZrₓTi₁₋ₓ]O₃0<x<1, also referred to herein as PZT). PZT is a ceramic perovskite material that has a spontaneous polarization which can be reversed in the presence of an electric field.

Ferroelectric films have been proposed as promising recording media, with a bit state corresponding to a spontaneous polarization direction of the media, wherein the spontaneous polarization direction is controllable by way of application of an electric field. Ferroelectric films can achieve ultra high bit recording density because the thickness of a 180° domain wall in ferroelectric material is in the range of a few lattices (1-2 nm).

Sensing of spontaneous polarization direction in a ferroelectric media by a probe tip (also referred to herein as a tip) can be performed destructively by applying a test potential to a portion of the ferroelectric media while monitoring for displacement current. If no displacement current is detected, the portion of the ferroelectric media has a polarity corresponding to the test potential. If a displacement current is detected, the portion of the ferroelectric media has a polarity that is opposite a polarity of the test potential. The opposite polarity of the portion is destroyed once detected, and must be re-written. Detecting and subsequently re-writing the portion (where an opposite polarity of the portion is destroyed) results in reduced data throughput performance. To minimize this reduction in data throughput performance, a separate write transducer can be employed. However, the separate write transducer includes potential write cycling with each read. Repeated probing and cycling can result in cycle and/or imprint fatigue failure of the probed and cycled portion of the ferroelectric media.

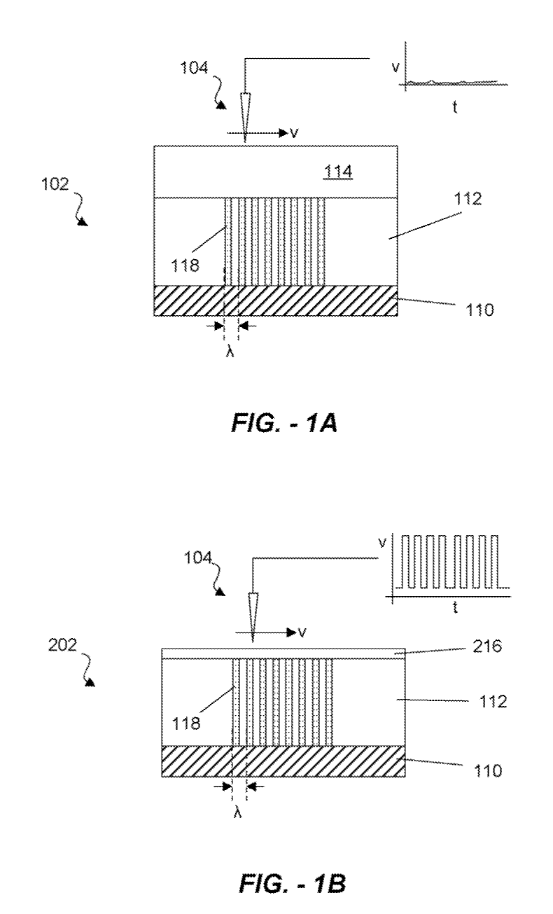

Referring to FIG. 1A, alternatively a method of reading information from a ferroelectric media 102 can include applying radio frequency (RF) sensing techniques to a probe tip 104 (also referred to herein as a tip) so that the tip 104 acts as an antenna for detecting a low RF signal. The ferroelectric media 102 can include, for example, a ferroelectric layer 112 (e.g. PZT) disposed over a substrate 110 and communicatively accessible to the tip 104. A wavelength λ of recorded information 118 associated with alternating polarization can be leveraged with scanning speed ν to modulate the signal frequency into the low RF range. Run length limited (RLL) coding can further be applied to constrain the spectrum of random data to the RF range. RF sensing techniques can make use of RF circuit(s) electrically associated with one or more tips to enable writing and/or reading for information storage.

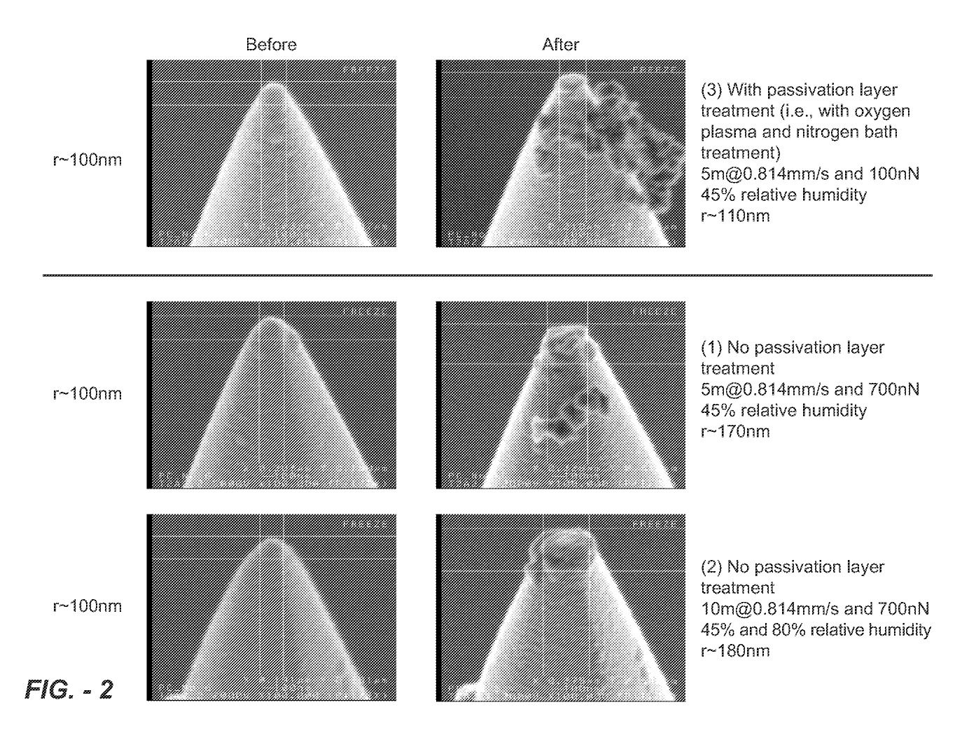

Detrimentally, a relatively thick layer of hydrocarbon contamination 114 can build up on the surface of a ferroelectric media 102 which can interfere with collecting desirable signals at low contact forces and can interfere with relative movement between the tip 104 and the media 102, increasing tip wear. Further, the hydrocarbon contamination layer 114 is sensitive to humidity, reducing consistency of the properties of the layer. As a result, obtaining an RF-charge signal sufficient for acceptable read/write performance can be difficult at tip-to-media surface contact forces on the order of 100 nN. Increasing contact force between the tip and media can enable a more pronounced RF-charge signal. A useful RF-charge signal having an acceptable signal-to-noise ratio (e.g. 5:1 and greater) is achievable with a substantial increase in contact force (e.g. 600 nN and greater). One explanation for the increase in RF-charge signal is that a gap between the media and the tip is made smaller when the force applied is larger (e.g. by urging the tip through the hydrocarbon layer). In addition, it is also possible that the RF-charge signal amplifies with the increase in contact area between the media and the tip when the force applied is made larger. However, applying higher forces places the tip-media interface under higher stress, promoting wear on one or both of the tip and the media surface. Referring to FIG. 2, three sets of scanning electron microscope (SEM) images show tip wear of atomic force tips under relevant scan conditions. A tip-to-media surface contact force of approximately 700 nN can wear a tip having a starting radius (i.e., radius of curvature) of approximately 100 nm to a final radius of (1) approximately 170 nm after traveling a distance of about approximately 5 m at a speed of approximately 0.8 mm/s at approximately 45% relative humidity, and (2) approximately 180 nm after traveling a distance of about approximately 10 m at a speed of approximately 0.8 mm/s at both approximately 45% and approximately 80% relative humidity.

Methods and systems for storing information in accordance with the present invention include a ferroelectric media with a passivation layer disposed over the surface of the media for improving an RF-charge signal. Referring to FIG. 1B, in an embodiment, a passivation layer 216 can comprise a nitrogen-carbon-oxygen (N—C—O) film. The N—C—O film can be formed having a thickness through the film that is smaller than a likely hydrocarbon contamination layer, narrowing a gap at the tip-media interface. The passivation layer 216 can be less hydrophilic than the surface of the ferroelectric layer 112 or the ferroelectric layer 112 with hydroxyl (OH) termination, resisting accumulation of a hydrocarbon contamination layer on the passivation layer 216. Further, the passivation layer 216 can reduce wear on one or both of the tip 104 and the media 202 by providing a lower resistance contact surface. Thus, the passivation layer 216 resembles a lubrication layer when compared with the surface of the hydrocarbon contamination layer 114 under a wide range of humidity conditions. The ferroelectric media 202 is made amenable to collecting a high resolution and amplitude RF-charge signal without unacceptably adverse wear at the tip-media interface.

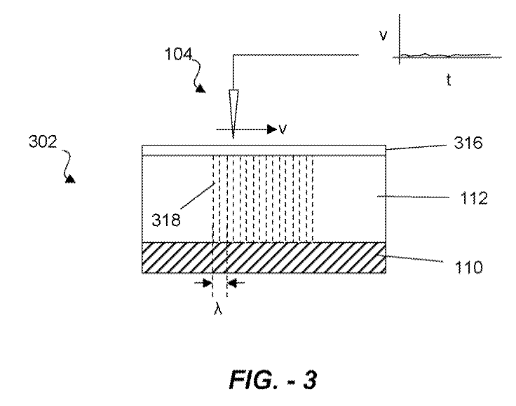

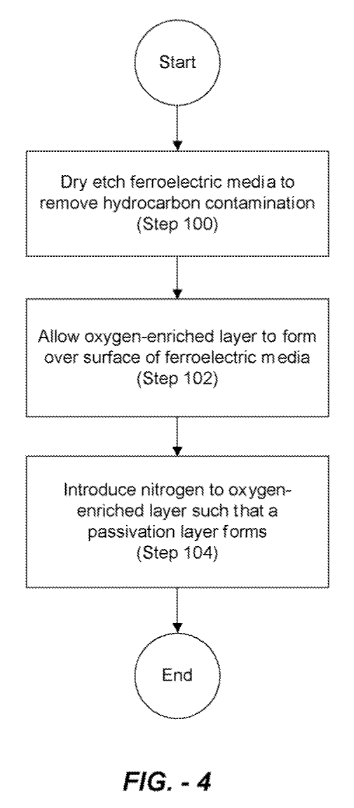

Referring to FIGS. 3 and 4, in an embodiment a method of forming a passivation layer on a ferroelectric media 302 can include dry etching the surface of the ferroelectric media in oxygen plasma to remove hydrocarbon-based contamination (Step 100). The oxygen plasma can comprise substantially oxygen. The oxygen plasma can comprise a mixture of oxygen and an inert gas (e.g. helium). The oxygen plasma can comprise a mixture of oxygen, nitrogen and helium. The hydrocarbon-based contamination, which can be several nanometers thick, is removed by one of, or a combination of, ion bombardment and oxidation. The oxygen plasma etching leaves behind oxygen-enriched layer 316 formed over ferroelectric layer 312 (Step 102). The oxygen-enriched layer 316 may comprise a layer of hydroxyl termination on the surface of the ferroelectric layer 112. The surface may also be enriched with oxygen-carbon species where the surface is briefly exposed to air (e.g., at 45% relative humidity for one hour). The layer 316 of the ferroelectric media 302 enriched with oxygen and/or oxygen-carbon species is generally hydrophilic. The RF-charge signal 320 obtained by the tip 104 from the hydrophilic ferroelectric media 302 will vary as the surrounding humidity varies. Adsorption of water (or moisture) on the hydrophilic surface may becomes excessive and the capacitive/charge coupling at the gap is made overly strong so that the process of the RF-charge signal tracing induces polarization reversals 318 under normal to high humidity condition (e.g., 35-80% relative humidity).

The surface is made less hydrophilic (or hydrophobic) when a wet or dry nitrogen gas is introduced. The wet nitrogen may be a gaseous mixture of nitrogen and water vapor. The oxygen and/or carbon-oxygen enriched surface of the ferroelectric media 302 can be bathed in a nitrogen gas (e.g., 0-15% relative humidity for five minutes) (Step 104). The nitrogen gas causes the surface of the ferroelectric media to be enriched with N—C—O (and/or N—O) species forming a passivation layer 216, as shown in FIG. 1B. The N—C—O (and/or N—O) passivation layer 216 makes the surface less hydrophilic so that water adsorption on the surface is minimized and polarization reversal due to excess capacitive/charge coupling is prevented over a wide range of humidity variation (approximately 35 to 80% relative humidity). An acceptable RF-charge signal 220 having signal-to-noise ratio of approximately 5:1 and greater is routinely obtainable at low force (approximately 100 nN) when the signal collection is made over the ferroelectric media 202 having undergoing the oxygen plasma and nitrogen passivation treatment. Furthermore, the RF-charge signal retains without unacceptable variation in signal-to-noise ratio under a usable range of humidity condition (35-80% RH). Referring again to FIG. 2, (3) it has been observed that a low contact force of approximately 100 nN on an oxygen plasma etched and then a nitrogen bath passivation treated ferroelectric media can flatten a tip having a starting radius of approximately 100 nm to a final radius of approximately 110 nm after traveling a distance of approximately 5 m at a speed of approximately 0.8 mm/s.

In alternative embodiments of system for storing information in accordance with the present invention, a cavity between the tip and the media surface can be filled with nitrogen gas enables to continuously extract a good RF signal at low force (e.g., 100 nN) and under ambient humidity (approximately 45% relative humidity) and temperature (approximately 20-25° C.). It has been observed that adding excess water (approximately 80% relative humidity) after the surface treatment does not affect the signal integrity noticeably. RF signal traces were observed over the duration of approximately ten days and exhibited “long-term stability” with negligible variation in signal-to-noise ratio.

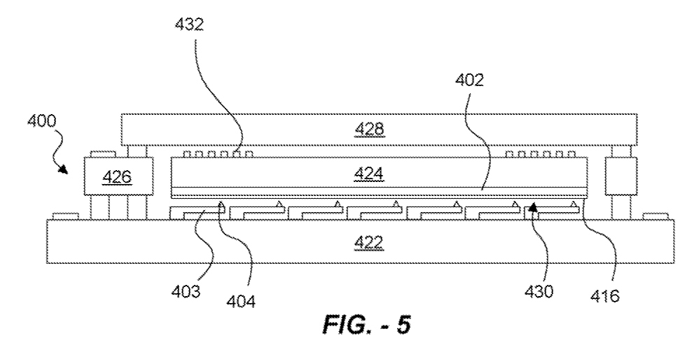

One such system implementing a nitrogen filled cavity is shown in FIG. 5. The system 400 comprises a tip die 422 arranged in opposition to a ferroelectric media 402 including a passivation layer 416 disposed on a media platform 424. Cantilevers 403 extend from the tip die 422, and tips 404 extend from respective cantilevers 403 toward the surface of the ferroelectric media 402. The media platform 424 is movable within a frame 426, with the frame 426 and media platform 424 comprising a media die 401. The media platform 424 can be movable within the frame 426 by way of thermal actuators, piezoelectric actuators, voice coil motors 432, etc. The media die 401 can be bonded with the tip die 422 and a cap die 428 can be bonded with the media die 401 to seal the media platform 424 within a cavity 430. Nitrogen can be introduced and sealed in the cavity 430.

In still further embodiments of systems for storing information in accordance with the present invention, a layer of a high-K dielectric (i.e. a material having a high dielectric constant, relative to silicon dioxide) can be formed or otherwise disposed over the ferroelectric media surface to enhance capacitive/charge coupling, thereby amplifying a detected RF-charge signal. The “effective” high-K dielectric layer at the tip-media interface can be approximately a nanometer or less. A high-K dielectric layer thicker than one nanometer can begin to detrimentally affect an RF-charge signal by “smearing out” the desired amplification achieved due to spreading and/or weakening of capacitive/charge coupling above a threshold thickness.

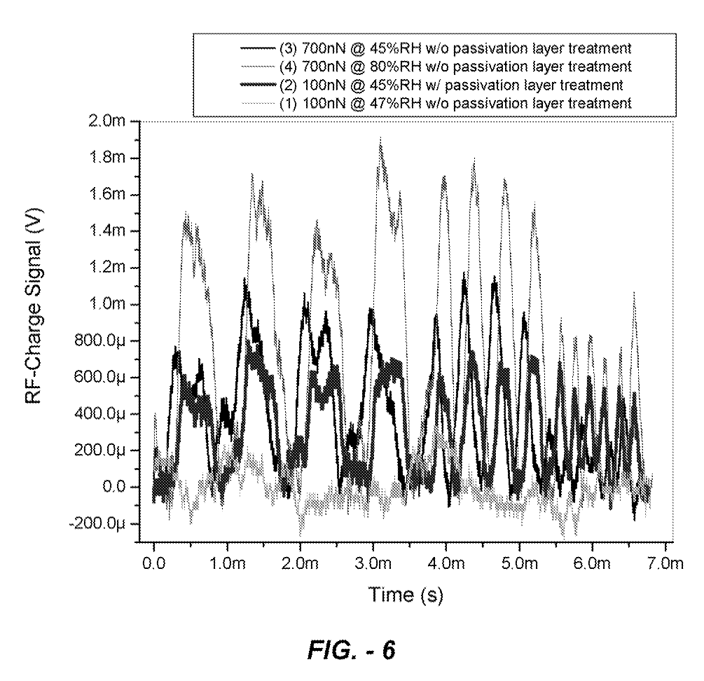

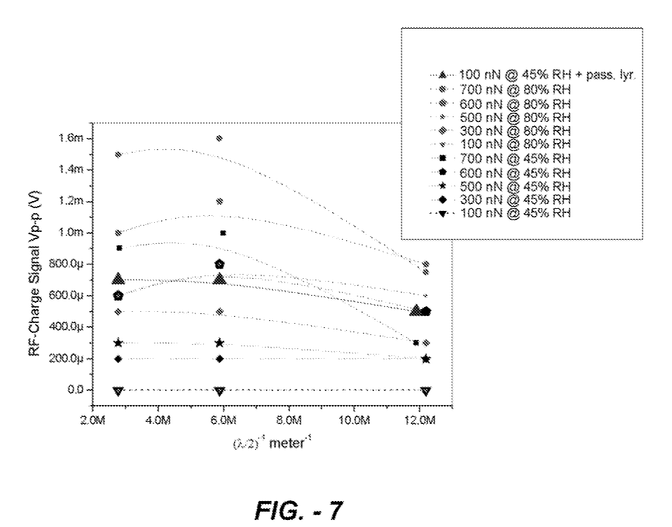

The amplification effect has been observed using water as a high-K dielectric medium. By increasing relative humidity from approximately 45% to approximately 80% (an excess water condition) at an applied force of the tip on the media of approximately 700 nN, the RF-charge signal detected by the tip roughly doubles. FIG. 6 is a set of RF-charge signal traces detected by an atomic force probe tip moving over a ferroelectric media under different operating conditions: 1. approximately 45% relative humidity and approximately 100 nN of tip-to-media contact force; 2. approximately 47% relative humidity, oxygen-plasma etched and nitrogen bath treated ferroelectric media and approximately 100 nN tip-to-media contact force; 3. approximately 45% relative humidity and approximately 700 nN tip-to-media contact force; and 4. approximately 80% relative humidity and approximately 700 nN tip-to-media contact force. It is noted that increasing humidity can increase adhesion force and thus contact force that may facilitate the amplification effect. FIG. 7 is a set of RF-charge signal traces detected by an atomic force probe tip moving over a ferroelectric media under the wet (approximately 80% relative humidity) and non-wet (approximately 45% relative humidity) conditions, as well as non-wet (approximately 45% relative humidity) with a passivation layer. A tip-to-media contact force of approximately 100 nN, approximately 300 nN, approximately 500 nN, approximately 600 nN is applied at the various conditions.

The foregoing description of the present invention has been presented for purposes of illustration and description. It is not intended to be exhaustive or to limit the invention to the precise forms disclosed. Many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. A system for reading information stored as ferroelectric domains comprising:
a media including:
a ferroelectric layer including the ferroelectric domains, and
a passivation layer formed over the ferroelectric layer;
a tip arranged in approximate contact with the passivation layer; and
wherein the tip detects a polarization signal corresponding to changes in polarization of the ferroelectric domains.

2. The system of claim 1, wherein the domains are arranged so that relative movement of the ferroelectric domains and the tip at a scan speed causes the polarization signal to have a frequency in the radio frequency range.

3. The system of claim 1, wherein the passivation layer includes one of (1) a nitrogen-carbon-oxygen film and (2) a nitrogen-oxygen film.

4. The system of claim 3, wherein the passivation layer is less hydrophilic than the ferroelectric layer.

5. The system of claim 3, wherein the ferroelectric layer is a hydroxyl terminated ferroelectric layer; and
wherein the passivation layer is less hydrophilic than the hydroxyl terminated ferroelectric layer.

6. The system of claim 3, wherein the passivation layer is hydrophobic.

7. The system of claim 2, wherein the domains include information arranged based on run length limited code; and
wherein the run length limited code causes the domains to change polarization at a frequency that corresponds to the radio frequency range.

8. The system of claim 1, further comprising:
a tip platform;
a plurality of cantilevers extending from the tip platform; and
a plurality of tips extending from corresponding cantilevers;
a media platform fixedly connected with the media;
wherein the media platform is positionable to allow the plurality of tips to access portions of the media.

9. A system for reading information stored as ferroelectric domains comprising:
a media including:
a ferroelectric layer including the ferroelectric domains, and
a high-K dielectric layer formed over the ferroelectric layer;
a tip arranged in approximate contact with the high-K dielectric layer; and
wherein the tip detects a polarization signal corresponding to changes in polarization of the ferroelectric domains of the ferroelectric layer.

10. The system of claim 9, wherein the domains are arranged such that the relative movement of the domains and the tip at a scan speed causes the polarization signal to have a frequency in the radio frequency range.

11. The system of claim 10, wherein the domains include information arranged based on run length limited code; and
wherein the run length limited code causes the domains to change polarization at a frequency that corresponds to the radio frequency range.

12. The system of claim 9, further comprising:
a tip platform;
a plurality of cantilevers extending from the tip platform; and
a plurality of tips extending from corresponding cantilevers;
a media platform fixedly connected with the media;
wherein the media platform is positionable to allow the plurality of tips to access portions of the media.

13. The system of claim 1, wherein said passivation layer is a lubrication layer.

14. The system of claim 13, wherein said passivation layer is one of (1) a nitrogen-carbon-oxygen film and (2) a nitrogen-oxygen film.

15. A system for reading information stored as ferroelectric domains comprising:
a media including:
a ferroelectric layer including the ferroelectric domains, and
a passivation layer formed over the ferroelectric layer;
a tip arranged in approximate contact with the passivation layer; and
wherein the tip is an antenna that detects a signal representing information.

16. A system for reading information stored as ferroelectric domains comprising:
a media including:
a ferroelectric layer including the ferroelectric domains, and
a high-K dielectric layer formed over the ferroelectric layer;
a tip arranged in approximate contact with the high-K dielectric layer; and
wherein the tip is an antenna to detect a signal representing information.

17. The system of claim 8, wherein the tip platform is moveably connected to the tip die; and
further comprising:
a cap die fixedly connected to the tip die;
wherein the ferroelectric media is suspended in a cavity between the cap die and the tip die; and
wherein the cavity includes nitrogen gas.

18. The system of claim 17, wherein the passivation layer includes one of (1) a nitrogen-carbon-oxygen film and (2) a nitrogen-oxygen film.

19. The system of claim 17, wherein the passivation layer is less hydrophilic than the ferroelectric layer.

20. The system of claim 17, wherein the ferroelectric layer is a hydroxyl terminated ferroelectric layer; and wherein the passivation layer is less hydrophilic than the hydroxyl terminated ferroelectric layer.

21. The system of claim 17, wherein the passivation layer is hydrophobic.

22. The system of claim 18, wherein the domains include information arranged based on run length limited code; and.
wherein the run length limited code causes the domains to change polarization at a frequency that corresponds to the radio frequency range.

23. The system of claim 1, wherein:
the tip that is electrically conductive; and
the tip is made chemically inert.

24. The system of claim 23, wherein:
the tip comprises silicon and is coated with one of platinum, chromium, and titanium.

25. The system of claim 24, wherein:
the tip comprises silicon and is coated with platinum; and
the tip is a catalyst.
